(19) United States
(12) Patent Application Publication
(10) Pub. No.: US 2026/0175700 A1
(43) Pub. Date: Jun. 25, 2026

(54) POWER CONVERSION SYSTEM

(71) Applicant: TOYOTA JIDOSHA KABUSHIKI KAISHA, Toyota-shi (JP)

(72) Inventor: Masato WATANABE, Toyota-shi (JP)

(73) Assignee: TOYOTA JIDOSHA KABUSHIKI KAISHA, Toyota-shi (JP)

(21) Appl. No.: 19/422,985

(22) Filed: Dec. 17, 2025

(30) Foreign Application Priority Data
Dec. 24, 2024 (JP) 2024-227350
Oct. 23, 2025 (JP) 2025-178534

(51) Int. Cl. B60L 15/00; H02J 7/50; H02M 3/24

(52) U.S. Cl. CPC B60L 15/007; H02J 7/575; B60L 2240/547; H02M 3/24

(57) ABSTRACT

A power conversion system includes a power conversion device and a relay section. The power conversion device includes a terminal to which a high-potential line and a low-potential line are connected. The power conversion device includes a terminal to which a high-potential line and a low-potential line are connected. The relay section is provided in the low-potential line. The relay section is provided between the terminal, a branch point, and the relay section. The relay section is switched between a first state in which the terminal is electrically connected to the branch point through the high-potential line and a second state in which the terminal is electrically connected to a portion between the relay section and the terminal in the low-potential line.

### CROSS-REFERENCE TO RELATED APPLICATION

This application claims priority to Japanese Patent Application No. 2024-227350 filed on Dec. 24, 2024, and to Japanese Patent Application No. 2025-178534 filed on Oct. 23, 2025. The disclosure of each of the above-identified applications, including the specification, drawings, and claims, is incorporated by reference herein in its entirety.

### BACKGROUND

### 1. Technical Field

The present disclosure relates to a power conversion system.

### 2. Description of Related Art

Japanese Unexamined Patent Application Publication No. 2013-90459 (JP 2013-90459 A) discloses a battery electric vehicle. The battery electric vehicle includes a battery, an AC-DC converter (power conversion device) for charging the battery, and a controller. The AC-DC converter converts alternating current power supplied from an external power supply to the vehicle into direct current power and outputs the direct current power to the battery. The controller controls the AC-DC converter.

### SUMMARY

In a case where the power conversion device is connected to a power storage device, a terminal voltage of the power conversion device on a side of the power storage device (hereinafter, also simply referred to as a “terminal voltage”) corresponds to a voltage of the power storage device. In a case where a voltage of the power storage device is low, a current of the power storage device increases, which may cause an overcurrent. On the other hand, in a case where the voltage of the power storage device is high, power conversion efficiency of the power conversion device may be excessively reduced. For such a reason, the voltage of the power storage device is desired to be within a predetermined reference voltage range according to a type of the power storage device.

Since the reference voltage range varies depending on the type of the power storage device, a range of the terminal voltage is required to correspond to the reference voltage range. For example, in a case of a power storage device having a high reference voltage range, a power conversion device having a high terminal voltage range is required, and in a case of a power storage device having a low reference voltage range, a power conversion device having a low terminal voltage range is required. Therefore, it is considered to appropriately select a suitable power conversion device having a terminal voltage range according to the reference voltage range from various power conversion devices prepared in advance, according to the type of the power storage device. In this case, by mounting a power conversion system including the selected power conversion device on the vehicle, power transmission can be appropriately performed by appropriately changing the voltage of the power storage device within the reference voltage range.

In recent years, the types of power storage devices have been diversified. Since the reference voltage range varies depending on the type of the power storage device, the reference voltage range is also diversified with the diversification of the types of the power storage device. As a result, it takes a considerable effort to select a suitable power conversion device as described above each time according to the type of the power storage device mounted on the vehicle.

The present disclosure provides a power conversion system for appropriately performing power transmission without requiring an effort to select a power conversion device regardless of the type of the power storage device mounted on the vehicle.

A power conversion system according to the present disclosure is mounted on a vehicle.

The power conversion system includes a first power conversion device, a second power conversion device, a first relay section, and a second relay section. The first power conversion device includes a first terminal pair to which a first power line pair connected to an inlet of the vehicle is connected, and a second terminal pair to which a second power line pair connected to a power storage device of the vehicle is connected.

The second power conversion device includes a third terminal pair to which a third power line pair connected to the inlet is connected, and a fourth terminal pair to which a fourth power line pair branched from the second power line pair is connected.

The second terminal pair includes a first terminal to which a first high-potential line that is a power line connected to a positive electrode of the power storage device among the second power line pair is connected, and a second terminal to which a first low-potential line that is a power line connected to a negative electrode of the power storage device among the second power line pair is connected.

The fourth terminal pair includes a third terminal to which a second high-potential line branched from the first high-potential line at a first branch point is connected, and a fourth terminal to which a second low-potential line branched from the first low-potential line at a second branch point is connected.

The first relay section is provided in the first low-potential line.

The second relay section is provided between the second terminal, the third terminal, the first branch point, and the first relay section.

The second relay section is switched between a first state in which the third terminal is electrically connected to the first branch point through the second high-potential line and a second state in which the third terminal is electrically connected to a portion of the first low-potential line between the first relay section and the second terminal.

With the above configuration, a connection state (series/parallel) between the first and second power conversion devices can be appropriately determined according to the states of the first and second relay sections. As a result, power transmission can be appropriately performed by changing a voltage of the power storage device within a reference voltage range regardless of a type of the power storage device mounted on the vehicle. As a result, an effort is not needed to select a suitable power conversion device each time according to the type of the power storage device. Therefore, according to the above configuration, the power transmission can be appropriately performed without the need for the effort to select the power conversion device, regardless of the type of the power storage device.

The power storage device may include a first battery and a second battery. The first battery includes the positive electrode connected to the first high-potential line. The second battery includes the negative electrode connected to the first low-potential line. The power conversion system may further include a switching device. The switching device switches between series connection and parallel connection of the first battery and the second battery between the first high-potential line and the first low-potential line.

With the above configuration, a connection state between the first battery and the second battery is appropriately switched between a series connection state and a parallel connection state according to the maximum output voltage of each of the power conversion devices. As a result, the power transmission can be appropriately performed without requiring the high voltage resistance of each of the power conversion devices.

According to the present disclosure, the power transmission can be appropriately performed without the need for the effort to select the power conversion device, regardless of the type of the power storage device mounted on the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of an electric power system including a vehicle equipped with an electric power conversion system according to the embodiment;

FIG. 2A is a diagram for describing a vehicle of a comparative example;

FIG. 2B is a diagram for describing a relationship between a voltage of a battery, a current of the battery, and a power conversion efficiency;

FIG. 3 is a diagram for describing an example of a flow of power during external charging in the present embodiment;

FIG. 4 is a diagram for describing another example of a flow of power during external charging in the present embodiment;

FIG. 5A is a diagram for describing a relationship between a voltage VB of a battery and a current in each of the comparative example and the embodiment;

FIG. 5B is a diagram for describing a relationship between a voltage VB of a battery and a current in each of the comparative example and the embodiment;

FIG. 6A is a flowchart showing an example of processing executed by the control device in Modification 1;

FIG. 6B is a flowchart showing an example of processing executed by the control device in Modification 2;

FIG. 6C is a flowchart showing an example of processing executed by the control device in Modification 3;

FIG. 6D is a flowchart showing an example of processing executed by the control device in Modification 4;

FIG. 7 is a diagram for describing a configuration of a relay section in Modification 5;

FIG. 8A is a flowchart for describing a procedure of setting and operating a target device in Embodiment 2;

FIG. 8B is a diagram for describing an advantage of Embodiment 2;

FIG. 9 is a diagram for describing an example of a detailed configuration of the battery and a switching circuit in Embodiment 3;

FIG. 10 is a diagram showing a relationship between a state of the relay section, the power conversion device, the first battery, and the second battery, a target value of output power of an entirety of the power conversion device, a maximum output voltage of each of the power conversion devices, and an input voltage of the battery in Embodiment 2; and

FIG. 11 is a flowchart for describing an example of a procedure for determining a connection state of the first battery and the second battery in Embodiment 2.

### DETAILED DESCRIPTION OF EMBODIMENTS

Hereinafter, an embodiment of the present disclosure will be described in detail with reference to the drawings. The same or corresponding parts in the drawing are designated by the same reference numerals, and the description thereof will not be repeated. The embodiment and each of the modifications may be appropriately combined with each other.

### Embodiment 1

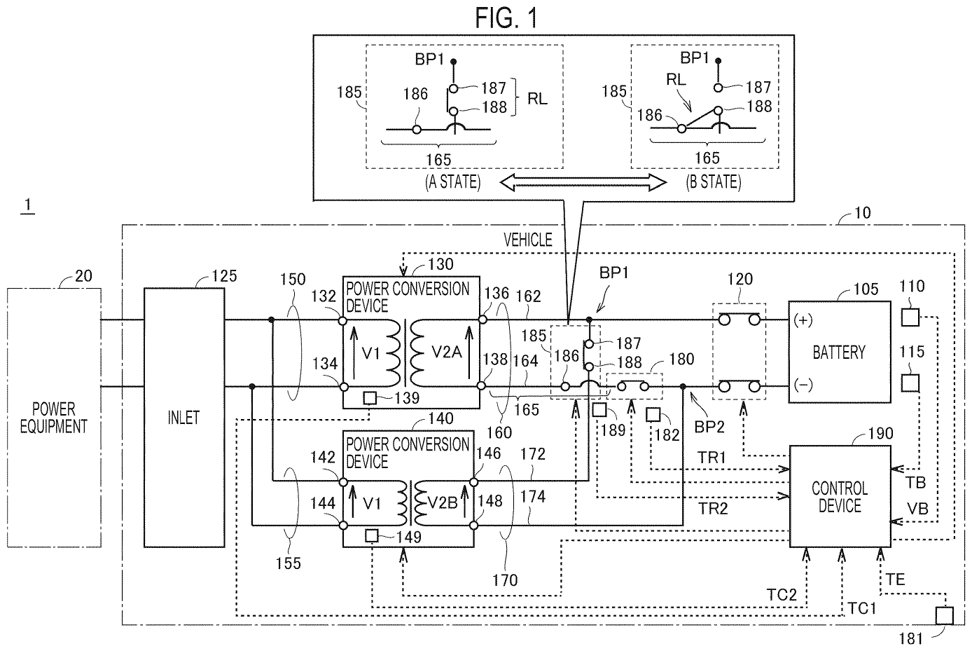

FIG. 1 is an overall configuration diagram of a power system including a vehicle to which a power conversion system according to Embodiment 1 is mounted. With reference to FIG. 1, a power system 1 includes a vehicle 10 and power equipment 20.

In this example, the vehicle 10 is a battery electric vehicle (BEV). The vehicle 10 may be another type of electrified vehicle, such as a plug-in hybrid electric vehicle (PHEV).

The vehicle 10 includes a battery 105, a voltage sensor 110, a temperature sensor 115, a system main relay (SMR) 120, an inlet 125, and power conversion devices 130, 140. The vehicle 10 further includes power line pairs 150, 155, 160, 170, relay sections 180, 185, temperature sensors 181, 182, 189, and a control device 190.

The battery 105 is an example of a power storage device that stores power for traveling of the vehicle 10. The battery 105 has a reference voltage range according to the type thereof. This range is appropriately predetermined by experiment or the like. The voltage sensor 110 measures the voltage VB of the battery 105 and outputs the measurement value. The temperature sensor 115 measures the temperature TB of the battery 105 and outputs the measurement value.

The SMR 120 is provided in the power line pair 160 (described later), and is in a closed state in Embodiment 1. The inlet 125 is connected to the power cable of the power equipment 20 and receives the power (alternating current power in this example) supplied from the power equipment 20.

The power conversion device 130 is an insulated converter including a transformer, and includes terminals 132, 134, 136, 138 and a temperature sensor 139. The terminals 132, 134 correspond to an example of a “first terminal pair” of the present disclosure, and a power line pair 150 is connected thereto. The power line pair 150 is connected to the inlet 125. The terminals 136, 138 correspond to an example of a “second terminal pair” of the present disclosure, and a power line pair 160 is connected thereto. The temperature sensor 139 measures the temperature TC1 of the power conversion device 130 and outputs the measurement value.

The power conversion device 130 operates during power transmission (hereinafter, also simply referred to as “power transmission”) between the vehicle 10 and the power equipment 20. The power transmission may be any of external charging or external power supply. The external charging refers to charging the battery 105 using the received power via the inlet 125. The external power supply refers to supplying power to an external device (for example, the power equipment 20 or another household electrical appliance) of the vehicle 10 using the power of the battery 105. During the external charging, the power conversion device 130 converts a voltage (terminal voltage V1) between the terminals 132, 134 and outputs the converted voltage (terminal voltage V2A) between the terminals 136, 138. The terminal voltage V1 corresponds to, for example, a voltage applied from the power equipment 20 to the inlet 125. On the other hand, during the external power supply, the power conversion device 130 converts the terminal voltage V2A and outputs the terminal voltage V1.

The power line pair 160 is connected to the battery 105 and includes a high-potential line 162 and a low-potential line 164. A first end of the high-potential line 162 is connected to the terminal 136, and a second end of the high-potential line 162 is connected to the positive electrode of the battery 105. A first end of the low-potential line 164 is connected to the terminal 138, and a second end of the low-potential line 164 is connected to the negative electrode of the battery 105.

The power conversion device 140 is an insulated type converter including a transformer and has terminals 142, 144, 146, 148 and a temperature sensor 149. The terminals 142, 144 correspond to an example of a “third terminal pair” in the present disclosure and are connected to the power line pair 155. The power line pair 155 branches from the power line pair 150 in this example, but may be connected in series to the inlet 125. The terminals 146, 148 correspond to an example of a “fourth terminal pair” in the present disclosure and are connected to the power line pair 170. The temperature sensor 149 measures the temperature TC2 of the power conversion device 140 and outputs the measurement value.

The power conversion device 140 operates during power transmission and converts, for example, a voltage (terminal voltage V1) between the terminals 142, 144 during external charging and outputs the converted voltage as a terminal voltage V2B to the terminals 146, 148. The terminal voltage V2B may be different from the terminal voltage V2A, but in the following description, the terminal voltage V2B is equal to the terminal voltage V2A for ease of understanding. On the other hand, the power conversion device 140 converts the terminal voltage V2B during external power supply and outputs the converted voltage as the terminal voltage V1.

The power line pair 170 branches from the power line pair 160 and includes a high-potential line 172 and a low-potential line 174. The high-potential line 172 branches from the high-potential line 162 at a branch point BP1, and an end part thereof is connected to the terminal 146. The low-potential line 174 branches from the low-potential line 164 at a branch point BP2, and an end part thereof is connected to the terminal 148.

The relay section 180 corresponds to a contact relay provided on the low-potential line 164. The relay section 185 is provided between the branch point BP1, the terminals 138, 146, and the relay section 180 and includes the contacts 186, 187, 188. The contact 186 is provided on a portion (low-potential line 165) between the relay section 180 and the terminal 138 of the low-potential line 164. The contacts 187, 188 are provided on the high-potential line 172 between the branch point BP1 and the terminal 146. The contact 188 can be connected to either the contact 187 or the contact 186.

The state of the relay section 185 in which the contact 188 is connected to the contact 187 is also referred to as an “A state”. In the A state, the contacts 187, 188 constitute a contact relay RL, and the terminal 146 is electrically connected to the branch point BP1 through the high-potential line 172. On the other hand, the state of the relay section 185 in which the contact 188 is connected to the contact 186 is also referred to as a “B state”. In the B state, the contacts 186, 188 constitute a contact relay RL, and the terminal 146 is electrically connected to the terminal 138 through the low-potential line 165. The relay section 185 is switched between the A state and the B state.

The temperature sensor 181 is an outside air temperature sensor, measures the temperature TE of the outside air of the vehicle 10, and outputs the measured value. The temperature sensor 182 measures the temperature TR1 of the relay section 180, and outputs the measured value. The temperature sensor 189 measures the temperature TR2 of the relay section 185, and outputs the measured value. The temperature TR2 is, for example, a temperature of the contact relay RL.

The control device 190 includes a memory and a processor (both not shown). The memory includes a random access memory (RAM) and a read-only memory (ROM). The ROM stores a program executed by the processor. The RAM functions as a working memory. The processor is, for example, a central processing unit (CPU), and executes various arithmetic processing according to the program.

The control device 190 controls various devices of the vehicle 10, such as the SMR 120, the power conversion devices 130, 140, and the relay sections 180, 185, according to the measurement values of the voltage VB and the temperatures TB, TE, TC1, TC2, TR1, and TR2. The control device 190 controls the power conversion devices 130, 140 such that output power (that is, output power of the entirety of the power conversion devices 130, 140 during the power transmission) from the entirety of the power conversion devices 130, 140 during the external charging is supplied to the battery 105. Alternatively, the control device 190 controls the power conversion devices 130, 140 such that output power (that is, output power of the entirety of the power conversion devices 130, 140 during the power transmission) from the entirety of the power conversion devices 130, 140 during the external power supply is supplied to the outside of the vehicle 10.

The voltage sensor 110, the temperature sensors 115, 181, 182, 189, the power conversion devices 130, 140, the power line pairs 150, 155, 160, 170, the relay sections 180, 185, and the control device 190 constitute an example of a “power conversion system” of the present disclosure.

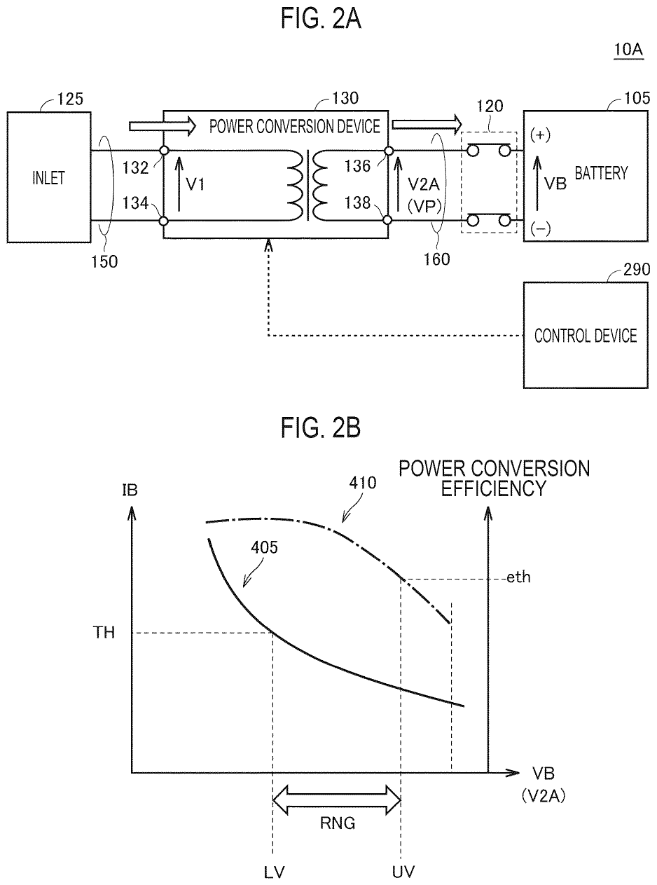

FIGS. 2A and 2B are diagrams for describing a vehicle of a comparative example and a relationship between the voltage VB and the current and the power conversion efficiency of the battery 105. With reference to FIG. 2A, the vehicle 10A of the comparative example is different from the vehicle 10 (FIG. 1) in that a power conversion system of the vehicle 10A does not include the power conversion device 140, the power line pairs 155, 170, and the relay sections 180, 185. However, the vehicle 10A of the comparative example is basically the same as the vehicle 10 in other aspects. In the comparative example, the terminal voltage V2A during external charging corresponds to the output voltage VP of the power conversion device 130. The output voltage VP corresponds to the voltage VB of the battery 105.

With reference to FIG. 2B, a line 405 represents a relationship between the current IB of the battery 105 and the voltage VB (output voltage VP). A line 410 represents a relationship between the power conversion efficiency of the power conversion device 130 and the voltage VB.

The reference voltage range RNG corresponds to a reference voltage range of the battery 105. In a case where the voltage VB is lower than the lower limit voltage LV of the reference voltage range RNG, the magnitude of the current of the battery 105 may exceed a threshold value TH, causing an overcurrent (line 405). On the other hand, in a case where the voltage VB is higher than the upper limit voltage UV of the reference voltage range RNG, the power conversion efficiency of the power conversion device 130 may excessively decrease and be lower than a predetermined efficiency eth (line 410). For such a reason, the output voltage VP corresponding to the voltage VB is limited within a specific allowable range in the reference voltage range RNG.

Since the reference voltage range RNG varies depending on the type of the battery 105, the range of the output voltage VP (terminal voltage V2A) is required to be corresponding to the reference voltage range RNG. For example, in the comparative example, the power conversion device 130 having a high range of the output voltage VP is required for the battery 105 having the high reference voltage range RNG, and the power conversion device 130 having a low range of the output voltage VP is required for the battery 105 having the low reference voltage range RNG. Therefore, it is considered to appropriately select the suitable power conversion device 130 having the range of the output voltage VP (terminal voltage V2A) corresponding to the reference voltage range RNG in accordance with the type of the battery 105 from among various power conversion devices prepared in advance in the factory or the like. In this case, by mounting the power conversion system including the selected power conversion device on the vehicle 10A, the power transmission can be appropriately performed by appropriately changing the voltage VB within the reference voltage range RNG.

In recent years, the types of the on-vehicle battery have been diversified, and various types of on-vehicle batteries can be mounted on the vehicle 10A as the battery 105. Since the reference voltage range RNG varies depending on the type of the on-vehicle battery, the reference voltage range RNG is also diversified along with the diversification of the types of the on-vehicle battery. As a result, it takes a lot of time to appropriately select the suitable power conversion device each time in accordance with the type of the on-vehicle battery used as the battery 105.

On the other hand, the power conversion system according to Embodiment 1 has a configuration for addressing such a problem. Hereinafter, this point will be described.

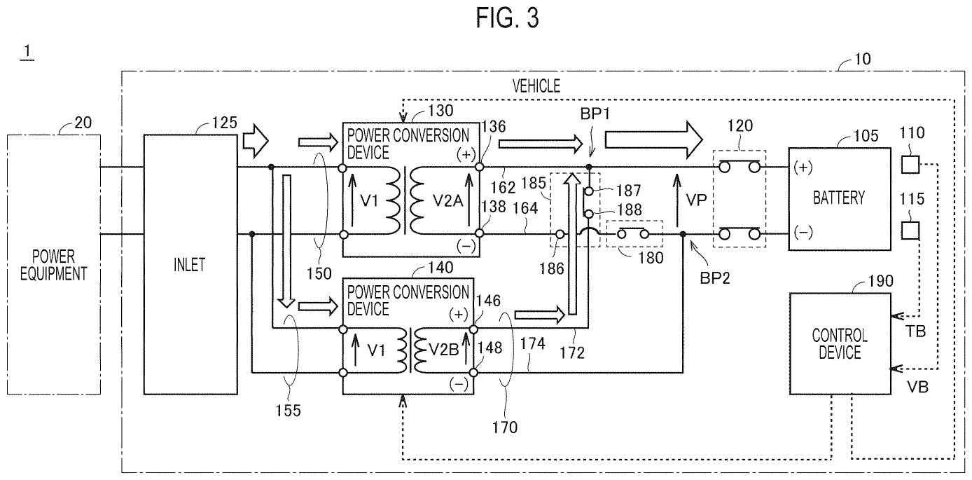

FIG. 3 is a diagram for describing an example of a flow of power during external charging in Embodiment 1. With reference to FIG. 3, in this example, the relay section 180 is in the closed state, and the relay section 185 is in the A state (FIG. 1). In this case, since the terminal 146 is connected to the branch point BP1 through the high-potential line 172, the power conversion devices 130, 140 are connected in parallel. As a result, a total current (large current) of the output current of the power conversion device 130 and the output current of the power conversion device 140 is supplied to the battery 105 through the SMR 120 as the output current of an entirety of the power conversion devices. A voltage (output voltage VP) of the output power of the entirety of the power conversion devices is equal to each of the terminal voltages V2A and V2B.

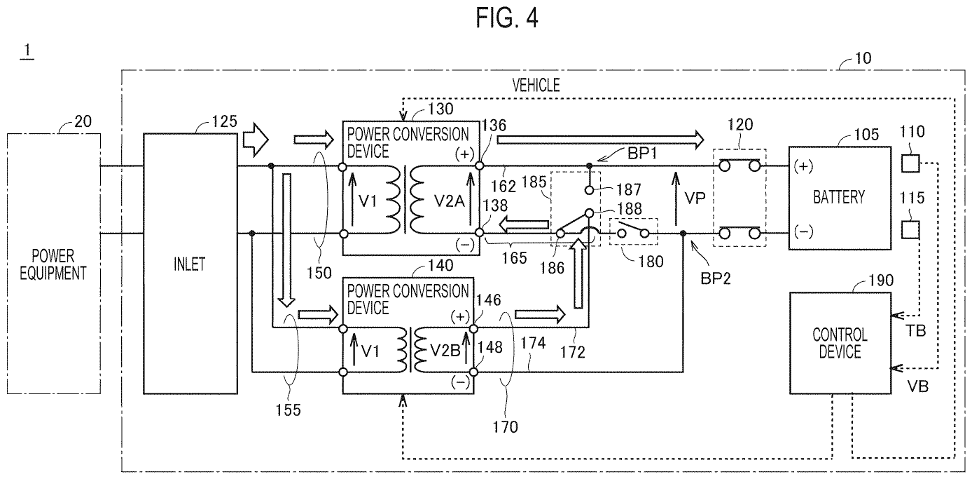

FIG. 4 is a diagram for describing another example of a flow of power during external charging in Embodiment 1. With reference to FIG. 4, in this example, the relay section 180 is in the open state, and the relay section 185 is in the B state (FIG. 1). In this case, since the terminal 146 is connected to the terminal 138 through the high-potential line 172 and the low-potential line 165, the power conversion devices 130, 140 are connected in series. As a result, a total voltage of the terminal voltages V2A and V2B is applied to the battery 105 as the output voltage VP. In this case, the output current of the entirety of the power conversion devices 130, 140 is smaller than that of the example in FIG. 3 (for example, it may be half of that of the example in FIG. 3).

In Embodiment 1, in a case of the battery 105 in which the voltage VB (reference voltage range RNG) is relatively low, the power conversion devices 130, 140 can be connected in parallel by setting the relay section 180 to the closed state and the relay section 185 to the A state as in FIG. 3. As a result, the battery 105 can be charged with a large current, or the power of the battery 105 can be supplied to the external device. On the other hand, in a case of the battery 105 in which the voltage VB (reference voltage range RNG) is relatively high, the power conversion devices 130, 140 can be connected in series by setting the relay section 180 to the open state and the relay section 185 to the B state as in FIG. 4. As a result, the voltage VB can be increased to a desired voltage within the reference voltage range RNG (for example, the power conversion efficiency of each of the power conversion devices can be increased to a voltage higher than the predetermined efficiency eth in FIG. 2B) while suppressing a decrease in the power conversion efficiency during the charging of the battery 105. The high voltage can be applied from the battery 105 to the external device through the inlet 125.

As described above, in Embodiment 1, the connection state (series/parallel) between the power conversion devices 130, 140 can be determined according to the states of the relay sections 180, 185. By appropriately switching the connection state, the power transmission such as the external charging can be appropriately performed as described above. That is, in order to appropriately perform the power transmission as described above, the power conversion system of Embodiment 1 need only be mounted on the vehicle 10, and the states of the relay sections 180, 185 need only be determined according to the voltage of the battery 105. As a result, it is sufficient to prepare only the minimum necessary (for example, one) type of power conversion system in a factory or the like, and it is not necessary to select a suitable power conversion device each time according to the type of the battery 105. Therefore, the type of the in-vehicle power conversion system prepared in a factory or the like can be reduced to a minimum necessary amount. As described above, according to Embodiment 1, the power transmission can be appropriately performed without requiring the time for selecting the power conversion device regardless of the type of the battery 105.

The connection state (series/parallel) between the power conversion devices 130, 140 is fixed by an operator (for example, by welding) in consideration of the reference voltage range RNG of the battery 105. For example, in a case where the reference voltage range RNG is known to be not so high in advance, the output voltage VP does not need to be high. Therefore, the states of the relay sections 180, 185 may be fixed such that the power conversion devices 130, 140 are always connected in parallel and the battery 105 is charged (or the battery 105 is discharged) with a large current.

It is preferable that the connection state is appropriately switched by the control device 190 in accordance with the measurement value of the voltage VB from the voltage sensor 110. In this case, in a case where the measurement value of the voltage VB is lower than a predetermined reference value, the control device 190 controls the relay section 180 to be in the closed state and the relay section 185 to be in the A state as shown in FIG. 3. On the other hand, in a case where the measurement value of the voltage VB is equal to or higher than the reference value, the relay section 180 is controlled to be in the open state and the relay section 185 is controlled to be in the B state as shown in FIG. 4.

With such a configuration, in a case where the measurement value of the voltage VB exceeds the reference value, the relay section 180 is automatically switched from the closed state to the open state and the relay section 185 is automatically switched from the A state to the B state by the control device 190. Therefore, with the above configuration, the series/parallel connection of the power conversion devices 130, 140 is appropriately switched in response to a change in the voltage VB. For example, in a case where the voltage VB is low, the power conversion devices 130, 140 are connected in parallel, so that the battery 105 is charged with a large current, and the charging time is appropriately shortened. On the other hand, in a case where the external charging is performed and the voltage VB increases, the connection state of these power conversion devices is switched from parallel to series, and the output voltage VP increases. Therefore, the voltage VB can be increased to a desired voltage within the reference voltage range RNG while suppressing a decrease in the power conversion efficiency. As described above, with the control by the control device 190, the power transmission such as the external charging can be appropriately performed.

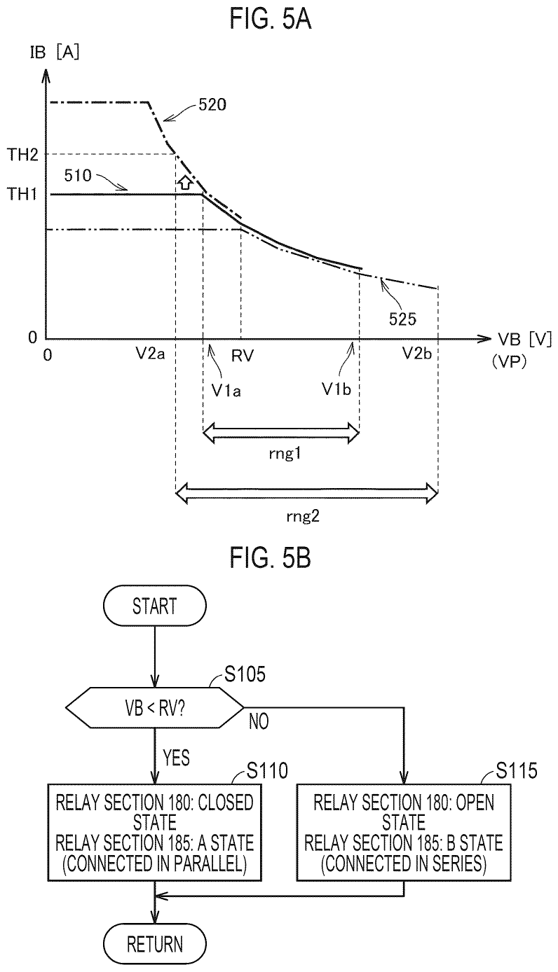

FIG. 5A is a graph for describing a relationship between the voltage VB (output voltage VP) and the current IB in each of the above-described comparative example (FIG. 2A) and Embodiment 1. With reference to FIGS. 5A and 5B, a line 510 represents the relationship in the comparative example. A line 520 represents the relationship in a case where the power conversion devices 130, 140 are connected in parallel in Embodiment 1 (FIG. 3). A line 525 represents the relationship in a case where the power conversion devices 130, 140 are connected in series in Embodiment 1 (FIG. 4).

The voltage range rng1 is an allowable range (restriction range) of the output voltage VP of the power conversion device 130 of the comparative example. In the comparative example, since the output voltage VP is limited to the voltage range rng1 determined based on the reference voltage range RNG, the voltage VB is also limited to the voltage range rng1. As a result, in a case where the voltage VB is lower than the lower limit voltage V1a, the current IB is limited, and the battery 105 cannot be charged using the current LB larger than the threshold value TH1 (line 510). The threshold value TH1 corresponds to, for example, the magnitude of the allowable upper limit current of the power conversion device 130. In addition, in the comparative example, in a case where the voltage VB is higher than the upper limit voltage V1b, the power conversion efficiency is excessively reduced. Therefore, it is difficult to make the voltage VB higher than the upper limit voltage V1b.

On the other hand, in Embodiment 1, the connection states (series/parallel) of the power conversion devices 130, 140 are switchable. Therefore, the allowable range (restriction range) of the output voltage VP from the entirety of the power conversion devices 130, 140 is represented by a voltage range rng2 wider than the voltage range rng1. The voltage range rng2 is determined based on the reference voltage range RNG.

In Embodiment 1, in a case where the measurement value of the voltage VB is lower than the reference value RV (for example, 500 V), the relay sections 180, 185 are controlled such that the power conversion devices 130, 140 are connected in parallel as shown in FIG. 3. As a result, unlike the comparative example in which the current can flow to the allowable upper limit current only in the power conversion device 130, the current can flow to the allowable upper limit current in each of the power conversion devices 130, 140. As a result, unlike the comparative example, the allowable upper limit current does not flow to each of the power conversion devices unless the output voltage VP is lower than the lower limit voltage V2a of the voltage range rng2. Therefore, the battery 105 can be charged with a large current (with a current having a magnitude of the threshold value TH2 at maximum) (line 520).

On the other hand, in a case where the measurement value of the voltage VB exceeds the reference value RV as the external charging proceeds, the relay sections 180, 185 are controlled such that the power conversion devices 130, 140 are connected in series as shown in FIG. 4. As a result, in Embodiment 1, the power conversion efficiency is still within the allowable range even in a case where the output voltage VP exceeds the upper limit voltage V1b, and the output voltage VP can be increased to the upper limit voltage V2b (>V1b) of the voltage range rng2 at maximum (line 525). This is different from the comparative example in which the power conversion efficiency excessively decreases in a case where the output voltage VP exceeds the upper limit voltage V1b. Therefore, the battery 105 having the high reference voltage range RNG can be charged while the excessive decrease in the power conversion efficiency is suppressed. In this case, for example, each of the terminal voltages V2A and V2B is lower than the upper limit voltage UV (FIG. 2B), and the power conversion efficiency of each power conversion device is prevented from falling below the predetermined efficiency eth.

FIG. 5B is a flowchart showing an example of processing executed by the control device 190 in Embodiment 1. The flowchart is repeatedly executed during the external charging. Hereinafter, steps will be abbreviated as “S”.

With reference to FIG. 5B, the control device 190 determines whether the measurement value of the voltage VB is smaller than the reference value RV (S105). In a case where the measurement value of the voltage VB is smaller than the reference value RV (YES in S105), the control device 190 controls the relay sections 180, 185 such that the power conversion devices 130, 140 are connected in parallel as shown in FIG. 3. Specifically, the control device 190 controls the relay section 180 to be in the closed state and the relay section 185 to be in the A state (S110). On the other hand, in a case where the measurement value of the voltage VB is equal to or higher than the reference value RV (NO in S105), the control device 190 controls the relay sections 180, 185 such that the power conversion devices 130, 140 are connected in series as shown in FIG. 4. Specifically, the control device 190 controls the relay section 180 to be in the open state and the relay section 185 to be in the B state (S115). After S110 or S115, the processing returns to S105.

As described above, according to Embodiment 1, the power transmission such as the external charging can be appropriately performed without the need to select the power conversion device in the factory or the like regardless of the type of the battery 105.

### Modification 1

In a case where the measurement value of the voltage VB is smaller than the reference value RV in S105 (FIG. 5B), the control device 190 may control the relay sections 180, 185 according to the measurement value of the temperature TB of the battery 105.

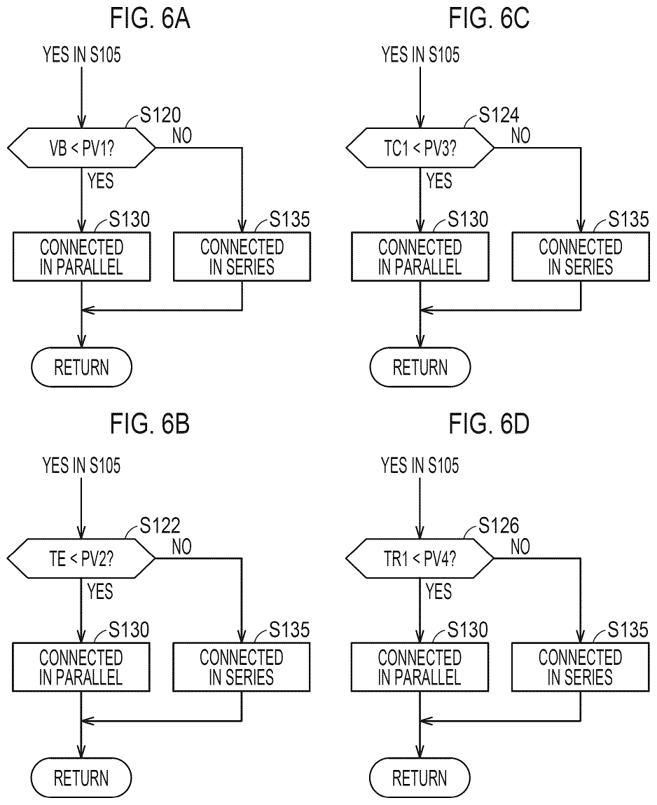

FIG. 6A is a flowchart showing an example of processing executed by the control device 190 in Modification 1. The flowchart is executed instead of S110 (FIG. 5B).

With reference to FIG. 6A, the control device 190 determines whether the measurement value of the temperature TB is lower than the predetermined value PV1 (S120). In a case where the measurement value of the temperature TB is lower than the predetermined value PV1 (YES in S120), the battery 105 is not overheated even in a case where the battery 105 is charged with a large current. Therefore, the control device 190 controls the relay sections 180, 185 such that the power conversion devices 130, 140 are connected in parallel as shown in FIG. 3 (S130). On the other hand, in a case where the measurement value of the temperature TB is equal to or higher than the predetermined value PV1 (NO in S120), the battery 105 may be overheated in a case where the battery 105 is charged with a large current. Therefore, the control device 190 controls the relay sections 180, 185 such that the power conversion devices 130, 140 are connected in series as shown in FIG. 4 (S135). After S130 or S135, the processing returns to S105 of FIG. 5B.

According to Modification 1, in a case where the voltage VB is low and the temperature TB is low, the power conversion devices 130, 140 are connected in parallel. As a result, the battery 105 can be charged with a large current and the battery 105 can be effectively warmed. As a result, the time required for power transmission, such as external charging, can be appropriately shortened. On the other hand, in a case where the voltage VB is low and the temperature TB is high, the power conversion devices 130, 140 are connected in series. As a result, the power transmission can be performed while effectively avoiding the overheating of the battery 105.

### Modification 2

In a case where the measurement value of the voltage VB is smaller than the reference value RV in S105 (FIG. 5B), the control device 190 may control the relay sections 180, 185 according to the measurement value of the temperature TE of the outside air.

FIG. 6B is a flowchart showing an example of a process executed by the control device 190 in Modification 2. The flowchart is executed instead of S110 (FIG. 5B).

With reference to FIG. 6B, the control device 190 determines whether the measurement value of the temperature TE is lower than a predetermined value PV2 (S122). In a case where the measurement value of the temperature TE is lower than the predetermined value PV2 (YES in S122), the temperature TB of the battery 105 tends to be low. Therefore, in order to appropriately shorten the time of the power transmission, the control device 190 controls the relay sections 180, 185 such that the power conversion devices 130, 140 are connected in parallel as shown in FIG. 3 (S130). On the other hand, in a case where the measurement value of the temperature TE is equal to or higher than the predetermined value PV2 (NO in S122), the temperature TB tends to be high. Therefore, in order to avoid the overheating of the battery 105, the control device 190 controls the relay sections 180, 185 such that the power conversion devices 130, 140 are connected in series as shown in FIG. 4 (S135). After S130 or S135, the processing returns to S105 of FIG. 5B.

According to Modification 2, as in Modification 1, the overheating of the battery 105 can be effectively avoided while appropriately shortening the time required for the power transmission.

### Modification 3

In a case where the measurement value of the voltage VB is lower than the reference value RV in S105 (FIG. 5B), the control device 190 may control the relay sections 180, 185 in accordance with the measurement value of the temperature TC1 of the power conversion device 130.

FIG. 6C is a flowchart showing an example of a process executed by the control device 190 in Modification 3. The flowchart is executed instead of S110 (FIG. 5B).

With reference to FIG. 6C, the control device 190 determines whether the measurement value of the temperature TC1 is lower than the predetermined value PV3 (S124). In a case where the measurement value of the temperature TC1 is lower than the predetermined value PV3 (YES in S124), the overheating of the power conversion device 130 does not occur even in a case where a large current flows through the battery 105 and the power conversion device 130. Therefore, the control device 190 controls the relay sections 180, 185 such that the power conversion devices 130, 140 are connected in parallel as shown in FIG. 3 in order to charge the battery 105 with a large current (S130). On the other hand, in a case where the measurement value of the temperature TC1 is equal to or higher than the predetermined value PV3 (NO in S124), the overheating of the power conversion device 130 may occur in a case where a large current flows through the battery 105 and the power conversion device 130. Therefore, the control device 190 controls the relay sections 180, 185 such that the power conversion devices 130, 140 are connected in series as shown in FIG. 4 (S135). After S130 or S135, the processing returns to S105 of FIG. 5B.

In the determination process of S124, the measurement value of the temperature TC2 of the power conversion device 140 may be used instead of the measurement value of the temperature TC1 of the power conversion device 130.

According to Modification 3, in a case where the voltage VB is low and the temperature TC1 or TC2 is high, the power conversion devices 130, 140 are connected in series. As a result, a large current as in the example in which these power conversion devices are connected in parallel does not flow through the power conversion devices 130, 140. Therefore, the amount of heat generated by these power conversion devices is prevented from excessively increasing. As a result, the power transmission can be performed while appropriately protecting the power conversion devices 130, 140 from overheating.

### Modification 4

In a case where the measurement value of the voltage VB is less than the reference value RV in S105 (FIG. 5B), the control device 190 may control the relay sections 180, 185 according to the measurement value of the temperature TR1 of the relay section 180.

FIG. 6D is a flowchart showing an example of a process executed by the control device 190 in Modification 4. The flowchart is executed instead of S110 (FIG. 5B).

With reference to FIG. 6D, the control device 190 determines whether the measurement value of the temperature TR1 is lower than a predetermined value PV4 (S126). In a case where the measurement value of the temperature TR1 is lower than the predetermined value PV4 (YES in S126), the relay section 180 is not overheated even in a case where a large current flows through the battery 105 and the relay section 180. Therefore, in order to charge the battery 105 with a large current, the control device 190 controls the relay sections 180, 185 such that the power conversion devices 130, 140 are connected in parallel as shown in FIG. 3 (S130). On the other hand, in a case where the measurement value of the temperature TR1 is equal to or higher than the predetermined value PV4 (NO in S126), the relay section 180 may be overheated in a case where a large current flows through the battery 105 and the relay section 180. Therefore, the control device 190 controls the relay sections 180, 185 such that the power conversion devices 130, 140 are connected in series as shown in FIG. 4 (S135).

In the determination process of S126, the measurement value of the temperature TR2 of the relay section 185 may be used instead of the measurement value of the temperature TR1 of the relay section 180.

According to Modification 4, in a case where the voltage VB is low and the temperature TR1 or TR2 is high, the power conversion devices 130, 140 are connected in series. As a result, a large current does not flow through the relay sections 180, 185 as in the example in which the power conversion devices are connected in parallel. Therefore, the heat generation amount of the relay sections 180, 185 is prevented from excessively increasing. As a result, power transmission can be performed while appropriately protecting the relay sections 180, 185 from overheating.

### Modification 5

In the above, the relay section 185 includes the contacts 186, 187, 188 (FIG. 1), but may have another configuration.

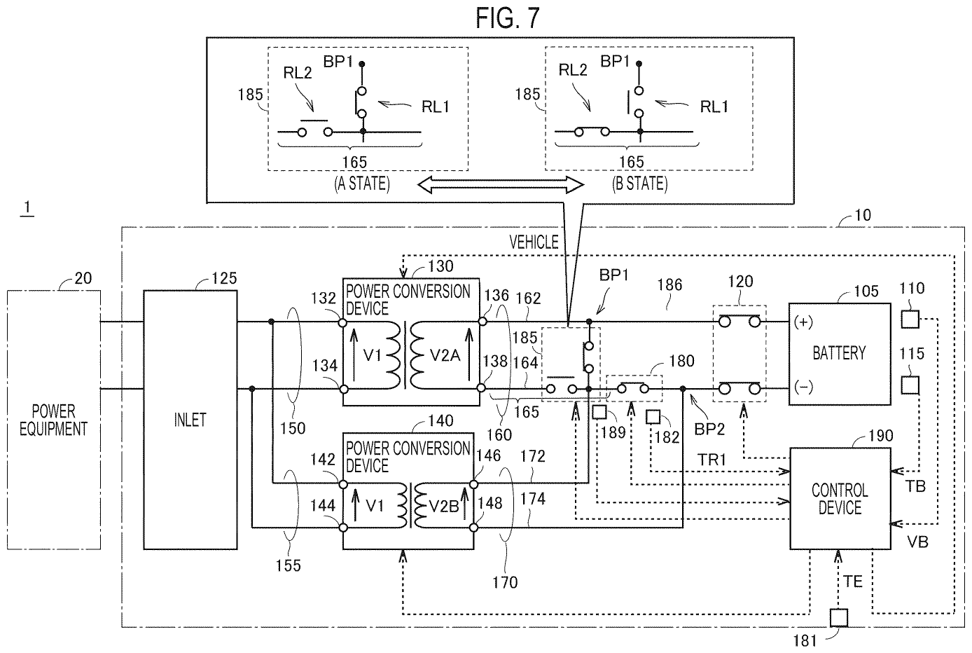

FIG. 7 is a diagram for describing a configuration of the relay section 185 in Modification 5. With reference to FIG. 7, the relay section 185 of Modification 5 is different from the relay section 185 of Embodiment 1 and Modifications 1 to 4 in that the contact relays RL1 and RL2 are included instead of the contacts 186, 187, 188. The A state of the relay section 185 is defined as a state in which the contact relay RL1 is in a closed state and the contact relay RL2 is in an open state. On the other hand, the B state of the relay section 185 is defined as a state in which the contact relay RL1 is in an open state and the contact relay RL2 is in a closed state. As described above, the A state and the B state may be defined as in FIG. 7.

### Embodiment 2

The control device 190 of Embodiment 2 is different from the control device 190 of Embodiment 1 in that the control device 190 of Embodiment 2 can operate only one of the power conversion devices 130, 140. In other words, the control device 190 controls the target device such that at least one of the power conversion device 130, 140 (hereinafter, also referred to as a “target device”) operates and the output power from the target device to the battery 105 or the output power from the target device to the outside of the vehicle 10 (output power of the target device during the power transmission) is supplied.

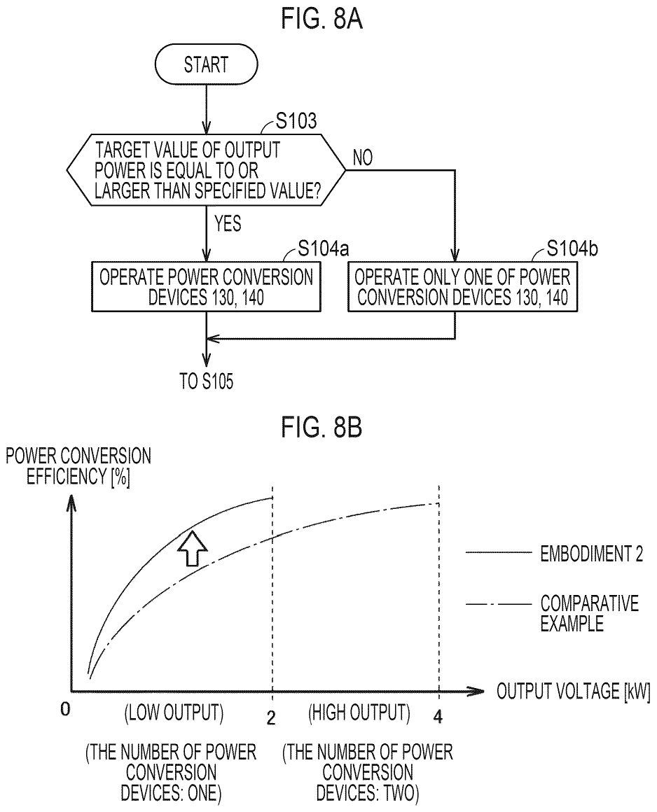

FIGS. 8A and 8B are flowcharts for describing a procedure of setting and operating the target device in Embodiment 2 and a diagram for describing an advantage of Embodiment 2. Hereinafter, steps will be abbreviated as “S”.

With reference to FIG. 8A, the control device 190 determines whether the target value of the output power is equal to or larger than a predetermined specified value (S103). The target value is appropriately determined based on the specification of the power equipment 20 and various conditions such as the voltage and the temperature of the battery 105. In a case where the target value is equal to or larger than the specified value, the control device 190 sets both of the power conversion devices 130, 140 as the target device and operates the target device (S104a). The specified value is, for example, a value of the maximum output power of each of the power conversion devices. The maximum output voltage corresponds to a maximum value of the terminal voltages V2A, V2B on the specification of the power conversion devices 130, 140. On the other hand, in a case where the target value of the output power is smaller than the specified value, the control device 190 sets only one of the power conversion devices 130, 140 as the target device and operates the target device (S104b). Thereafter, the processing proceeds to S105.

With reference to FIG. 8B, a relationship between the output power and the power conversion efficiency in each of Embodiment 2 and the comparative example will be described. In the comparative example, two power conversion devices are always operated regardless of the target value of the output power. In Embodiment 2, in a case where the target value of the output power is smaller than the specified value, only one power conversion device operates and the output power of the target value is supplied to the transmission destination. As a result, in Embodiment 2, the power loss during the power conversion is reduced in a range of the low output power as compared with the comparative example. As a result, the power conversion efficiency during the power transmission can be appropriately improved according to the output power.

### Embodiment 3

The power system 1 of Embodiment 3 is different from the power system 1 of Embodiment 1 in that the vehicle 10 further includes a switching circuit connected between the battery 105 and the SMR 120, and the battery 105 includes the first and second batteries. In other points, the power system 1 of Embodiment 3 is basically the same as the power system 1 of Embodiment 1 or 2.

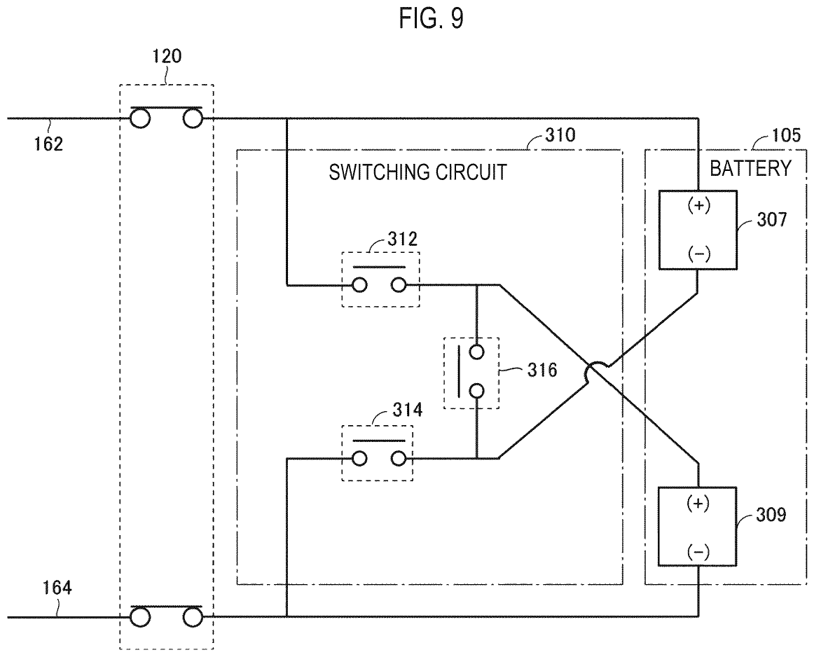

FIG. 9 is a diagram for describing an example of a detailed configuration of the battery 105 and the switching circuit in Embodiment 3. With reference to FIG. 9, the battery 105 includes a first battery 307 and a second battery 309. The first battery 307 has a positive electrode connected to the high-potential line 162 and a negative electrode connected to a switch 314 (described later). The second battery 309 has a positive electrode connected to a switch 312 (described later) and a negative electrode connected to the low-potential line 164.

The switching circuit 310 includes switches 312, 314, 316. For example, in a case where the switches 312, 314 are turned off and the switch 316 is turned on, the negative electrode of the first battery 307 is connected to the positive electrode of the second battery 309. As a result, the first battery 307 and the second battery 309 are electrically connected in series. On the other hand, in a case where the switches 312, 314 are turned on and the switch 316 is turned off, the negative electrode of the first battery 307 is connected to the low-potential line 164, and the positive electrode of the second battery 309 is connected to the high-potential line 162. As a result, the first battery 307 and the second battery 309 are electrically connected in parallel. The state of each of the switches may be switched by a user operation, may be automatically switched by the control device 190, or may be determined by being fixed by the user by welding or the like.

In Embodiment 2, the first battery 307 and the second battery 309 can be switched between being connected in series or in parallel between the high-potential line 162 and the low-potential line 164 by using the switches 312, 314, 316 of the switching circuit 310. As a result, the connection state of the first battery 307 and the second battery 309 can be appropriately switched between the series connection state and the parallel connection state according to the maximum output voltage of the power conversion devices 130, 140, so that the power transmission can be appropriately performed without increasing the high voltage resistance of each of the power conversion devices (details will be described later).

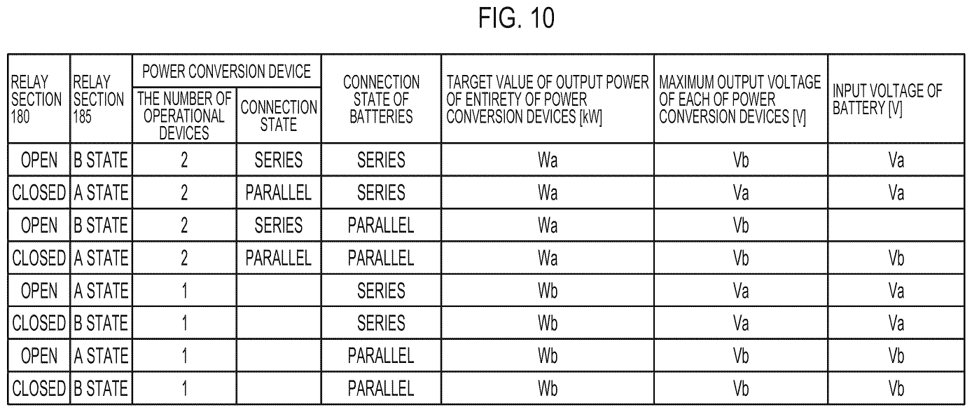

FIG. 10 is a diagram showing a relationship between a state of the relay sections 180, 185, the power conversion devices 130, 140, the first battery 307, and the second battery 309, a target value of output power of the entirety of the power conversion devices 130, 140, a maximum output voltage of each of the power conversion devices, and an input voltage of the battery 305 in Embodiment 2.

With reference to FIG. 10, in a case where the maximum output voltage of each of the power conversion devices is equal to or higher than a predetermined voltage (in this example, Va), the connection state of the first battery 307 and the second battery 309 is set to the series connection state by using the switching circuit 310. On the other hand, in a case where the power conversion devices 130, 140 are connected in parallel and the maximum output voltage is lower than the predetermined voltage (in this example, Vb), the connection state of the first battery 307 and the second battery 309 is set to the parallel connection state by using the switching circuit 310. In a case where the target value of the output power of the entirety of the power conversion devices 130, 140 is equal to or higher than the specified value (for example, Wa) or in a case where the target value is lower than the specified value (for example, Wb), the connection state of the first battery 307 and the second battery 309 is determined as described above. In this example, it is supposed that Va=800 [V], Vb=400 [V], and Wa=2×Wb [W]. In a case where the power conversion devices 130, 140 are connected in series, the connection state of the first battery 307 and the second battery 309 is set to the series connection state even in a case where the maximum output voltage is lower than the predetermined voltage.

The power conversion devices 130, 140 as the target device may be connected in parallel, and the first battery 307 and the second battery 309 may be connected in series. In this case, in order to charge the battery 105, the output voltage VP of each of the power conversion devices needs to be larger than the total voltage of the first battery 307 and the second battery 309. This requires the high voltage resistance of each of the power conversion devices.

Therefore, it is considered to charge the battery 105 by switching the relay sections 180, 185 as in Embodiment 1 to connect the power conversion devices 130, 140 in series. However, in this case, the output power (charging power to the battery 105) from the entirety of the power conversion devices is reduced.

On the other hand, in Embodiment 2, the power conversion devices 130, 140 can be operated in a state where the power conversion devices 130, 140 are connected in parallel and the first battery 307 and the second battery 309 are connected in parallel by using the switching circuit 310. In this case, in order to charge the battery 105, the output voltage VP does not need to be larger than the above total, and it is sufficient to be larger than the voltage of each of the first battery 307 and the second battery 309. Further, since the power conversion devices 130, 140 operate in a state of being connected in parallel, the output power is twice the power supplied from the single power conversion device, and is not reduced as described above. Therefore, the battery 105 can be charged without increasing the high voltage resistance of the power conversion devices 130, 140 and without reducing the output power. For example, even in a case where the maximum output voltage of each of the power conversion devices is Vb (<Va), the output power of Wa (>Wb) can be supplied to the battery 105 as the charging power.

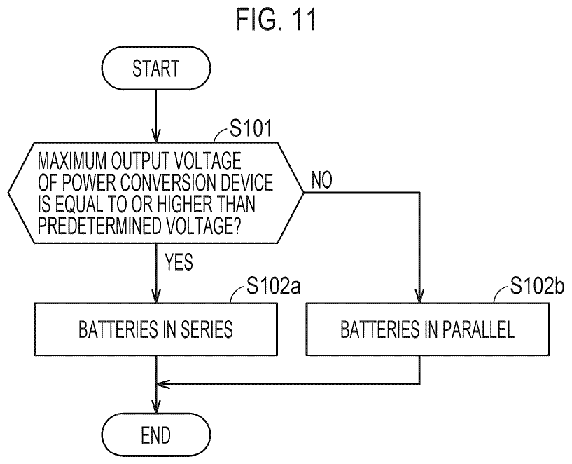

FIG. 11 is a flowchart for describing an example of a procedure for determining the connection state of the first battery 307 and the second battery 309 in Embodiment 2. With reference to FIG. 11, in a case where the maximum output voltage of each of the power conversion devices is equal to or higher than the predetermined voltage (YES in S101), the state of each of the switches of the switching circuit 310 is determined such that the first battery 307 and the second battery 309 are connected in series (S102a). On the other hand, in a case where the maximum output voltage is lower than the predetermined voltage (NO in S101), the state of each of the switches of the switching circuit 310 is determined such that the first battery 307 and the second battery 309 are connected in parallel (S102b). After S102a or S102b, the processing ends. Thereafter, for example, the processing of the flowchart of FIG. 5B or FIG. 8A is started.

As described above, in Embodiment 3, the connection state (series/parallel) of the first battery 307 and the second battery 309 can be switched by using the switching circuit 310. As a result, the power transmission can be appropriately performed without increasing the high voltage resistance of each of the power conversion devices.

### Other Modifications

Each of the power conversion devices 130, 140 is an insulated type converter in the above, but may be replaced with a converter such as a current reversible type boost chopper circuit.

The embodiments disclosed this time should be considered illustrative and not restrictive in all respects. The scope of the disclosure is shown by the scope of claims rather than the above description, and is intended to include all modifications within the meaning and scope equivalent to the scope of claims.

What is claimed is:

1. A power conversion system mounted on a vehicle, the power conversion system comprising:
a first power conversion device including a first terminal pair to which a first power line pair connected to an inlet of the vehicle is connected, and a second terminal pair to which a second power line pair connected to a power storage device of the vehicle is connected; and
a second power conversion device including a third terminal pair to which a third power line pair connected to the inlet is connected, and a fourth terminal pair to which a fourth power line pair branched from the second power line pair is connected, wherein:
the second terminal pair includes a first terminal to which a first high-potential line that is a power line connected to a positive electrode of the power storage device among the second power line pair is connected, and a second terminal to which a first low-potential line that is a power line connected to a negative electrode of the power storage device among the second power line pair is connected;
the fourth terminal pair includes a third terminal to which a second high-potential line branched from the first high-potential line at a first branch point is connected, and a fourth terminal to which a second low-potential line branched from the first low-potential line at a second branch point is connected;
the power conversion system further includes
a first relay section provided in the first low-potential line, and
a second relay section provided between the second terminal, the third terminal, the first branch point, and the first relay section; and
the second relay section is switched between a first state in which the third terminal is electrically connected to the first branch point through the second high-potential line and a second state in which the third terminal is electrically connected to a portion of the first low-potential line between the first relay section and the second terminal.

2. The power conversion system according to claim 1, further comprising:
a voltage sensor configured to output a voltage measurement value of the power storage device; and
a control device configured to control the first relay section and the second relay section according to the voltage measurement value,
wherein the control device is configured to
control, in a case where the voltage measurement value is lower than a reference value, the first relay section to a closed state and the second relay section to the first state, and
control, in a case where the voltage measurement value is equal to or higher than the reference value, the first relay section to an open state and the second relay section to the second state.

3. The power conversion system according to claim 2, further comprising a first temperature sensor configured to output a temperature measurement value of the power storage device,
wherein the control device is configured to control, in a case where the voltage measurement value is lower than the reference value, the first relay section to the open state and the second relay section to the second state when the temperature measurement value output from the first temperature sensor is equal to or higher than a first predetermined value.

4. The power conversion system according to claim 2, further comprising a second temperature sensor configured to output a temperature measurement value of outside air of the vehicle,
wherein the control device is configured to control, in a case where the voltage measurement value is lower than the reference value, the first relay section to the open state and the second relay section to the second state when the temperature measurement value output from the second temperature sensor is equal to or higher than a second predetermined value.

5. The power conversion system according to claim 2, further comprising a third temperature sensor configured to output a temperature measurement value of the first power conversion device or the second power conversion device,
wherein the control device is configured to control, in a case where the voltage measurement value is lower than the reference value, the first relay section to the open state and the second relay section to the second state when the temperature measurement value output from the third temperature sensor is equal to or higher than a third predetermined value.

6. The power conversion system according to claim 1, wherein:
the power storage device includes a first battery including the positive electrode connected to the first high-potential line and a second battery including the negative electrode connected to the first low-potential line; and
the power conversion system further includes a switching device that switches between series connection and parallel connection of the first battery and the second battery between the first high-potential line and the first low-potential line.
